(19) United States
(12) Patent Application Publication
(10) Pub. No.: US 2025/0173696 A1
(43) Pub. Date: May 29, 2025

(54) SYSTEM AND METHOD UTILIZING ELECTRICALLY ERASABLE PROGRAMMABLE RANDOM ACCESS MEMORY FOR ENCRYPTED DATA RETRIEVAL

(71) Applicant: BANK OF AMERICA CORPORATION, Charlotte, NC (US)

(72) Inventors: Nimish Ravindra Deshpande, Mumbai (IN); Prashant Anna Bidkar, Shakarpur (IN); Subrojyoti Dey, New Delhi (IN); Anoop Joseph, New Delhi (IN); Ankit Upadhyaya, Gurugram (IN)

(73) Assignee: BANK OF AMERICA CORPORATION, Charlotte, NC (US)

(21) Appl. No.: 18/521,447

(22) Filed: Nov. 28, 2023

(51) Int. Cl. G06Q 20/20; G06Q 20/40

(52) U.S. Cl. CPC G06Q 20/202; G06Q 20/4012

(57) ABSTRACT

Systems, computer program products, and methods are described herein for a secure transactional process utilizing a novel approach to data management within resource instruments. The described technology specifically addresses the need for enhanced security in electronic transactions by incorporating a system that dynamically retrieves, encrypts, stores, and subsequently erases transactional data in a secure manner. At the core of these systems is the use of electrically erasable programmable read-only memory (EEPRAM) which temporarily houses transaction details in an encrypted form. The details are securely fetched from an entity server following the verification of a transaction terminal integrity through unique cryptographic keys.

### TECHNOLOGICAL FIELD

Example embodiments of the present disclosure relate to utilizing electrically erasable programmable random access memory for encrypted data retrieval.

### BACKGROUND

The invention addresses the pervasive issue of malfeasant transactions by introducing a novel hardware-based solution. Traditional chip-based instruments store sensitive information locally, making them vulnerable to various forms of attack. There is a need for a solution that minimizes local storage of sensitive data and implementing stringent security measures, which would significantly reduce the chance of loss, offering a robust and innovative solution to protect end users and processing entities from the escalating problem of malfeasant activities.

Applicant has identified a number of deficiencies and problems associated with utilizing electrically erasable programmable random access memory for encrypted data retrieval. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for utilizing electrically erasable programmable random access memory for encrypted data retrieval. To combat this, the invention introduces a unique hardware capability in the form of an Electronically Erasable Programmable Random Access Memory (EEPRAM) embedded within the instrument chip. Unlike conventional instruments, the new chip does not store any user or instrument information. Instead, it relies on an innovative process for each transaction. When the instrument is used at a point of sale (POS) or an automated teller machine (ATM), the chip is activated through the electrical impulse supplied by the terminal. The chip only retains essential information, such as the issuing entity's name or communication channel specifics, which are used to initiate communication with the end servers.

One distinctive feature is the integration of an operating system (OS) level command within the chip of the instrument of the invention that verifies the authenticity of the POS or ATM by pinging its unique identifier to the end servers. Once authorized, the chip securely communicates with the end servers, employing a cryptographic hash key for added security. The entity sends encrypted instrument details and transaction restrictions, which are temporarily stored in the EEPRAM. After the transaction is completed and authenticated, the data in the EEPRAM is promptly deleted upon issuing a specific OS command.

In summary, the invention's unique hardware component, the EEPRAM, revolutionizes how card information is handled. The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for utilizing electrically erasable programmable random access memory for encrypted data retrieval, in accordance with an embodiment of the disclosure;

FIG. 2 illustrates a process flow for utilizing electrically erasable programmable random access memory for encrypted data retrieval, in accordance with an embodiment of the disclosure; and

FIG. 3 illustrates an instrument 300 utilizing electrically erasable programmable random access memory for encrypted data retrieval, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. As used herein, the term “resource instrument” refers to any physical or digital tool, device, or medium that facilitates the allocation, utilization, or management of resources in a system designed for transactions. This encompasses resource instruments embedded with microchips, mobile devices running mobile applications, and other tangible or intangible entities capable of storing value or representing identity credentials used in the authorization or execution of transactions. In the context of secure payment processing, a resource instrument may contain secure elements such as encrypted keys, user authentication data, or digital certificates that enable it to interact with point-of-sale terminals, automated teller machines, or online transaction systems. It is designed to initiate, authenticate, and conclude transactions while maintaining the integrity and security of the user's financial data. The resource instrument's design is such that it adheres to established protocols for data encryption and secure communication, ensuring that the resources it manages, be they monetary, informational, or access-related, are protected against unauthorized access or misuse.

The present disclosure introduces an innovative technology designed to address a critical issue in the field of resource instrument security. In the field of resource instrument security, the problem of credit and debit card misuse has been a persistent and escalating concern. A significant percentage of cardholders have fallen victim to unauthorized activities, leading to financial losses and personal distress. Traditional chip-based cards, while offering some security, still leave room for misuse by those who can access and misuse stored card information. Skimming devices and unauthorized transactions continue to pose a problem for consumers and financial institutions.

Accordingly, the present disclosure offers a groundbreaking solution to the problem of credit and debit card misuse. It introduces a secure resource instrument technology with a unique chip that stores minimal data and actively verifies the legitimacy of transactions and terminals, enhancing cardholder security. This technology reduces the chance of misuse by minimizing the exposure of sensitive card information and by ensuring that each transaction is authorized and encrypted. It represents a significant improvement over existing solutions, streamlining the process, enhancing accuracy, reducing resource usage, and automating tasks previously performed manually.

What is more, the present disclosure provides a technical solution to a technical problem. From a technical perspective, this innovation addresses a specific technical problem within the field of resource instrument security. The problem lies in the susceptibility of traditional chip-based cards to misuse, resulting in losses and compromised personal data. The provided technical solution involves the creation of a chip that minimizes data storage, enhances security by establishing secure communication with banks, and conducts thorough transaction integrity checks. This solution represents an improvement over existing methods, streamlining processes, reducing resource usage, eliminating manual input, and determining optimal resource allocation. It also introduces a computerized process that accomplishes tasks not previously performed, effectively bypassing unnecessary steps and conserving computing resources (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

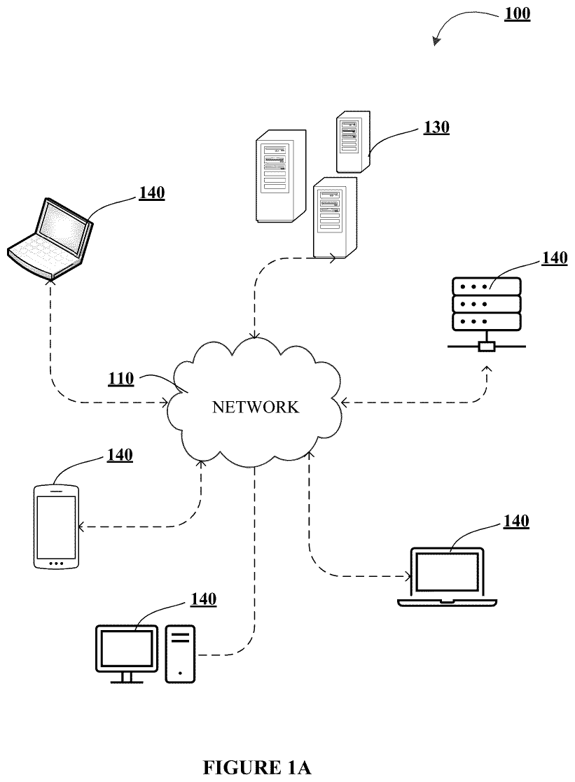

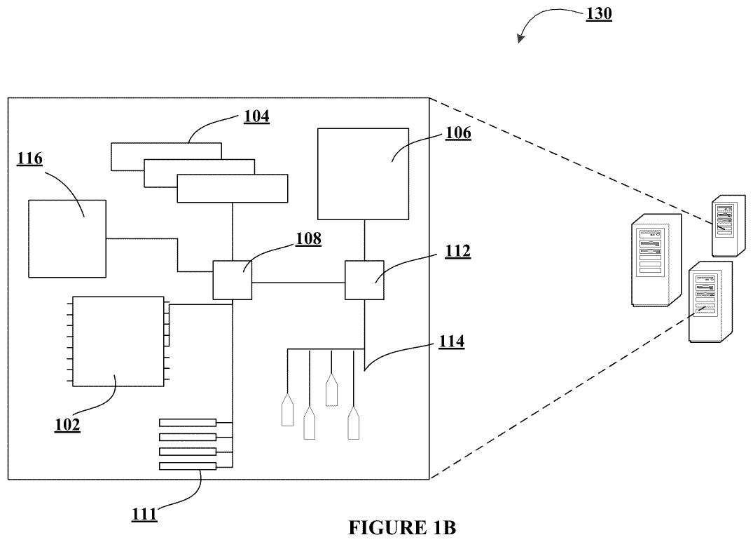

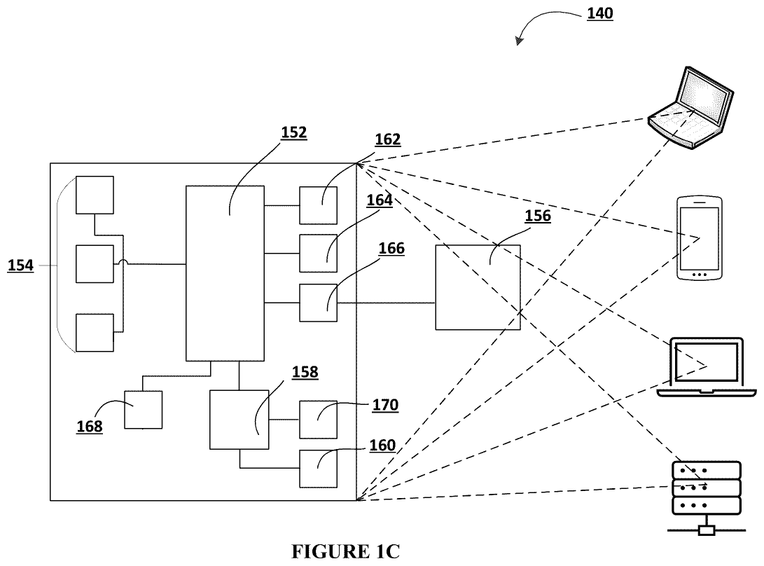

FIGS. 1A-1C illustrate technical components of an exemplary distributed computing environment 100 for utilizing electrically erasable programmable random access memory for encrypted data retrieval, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

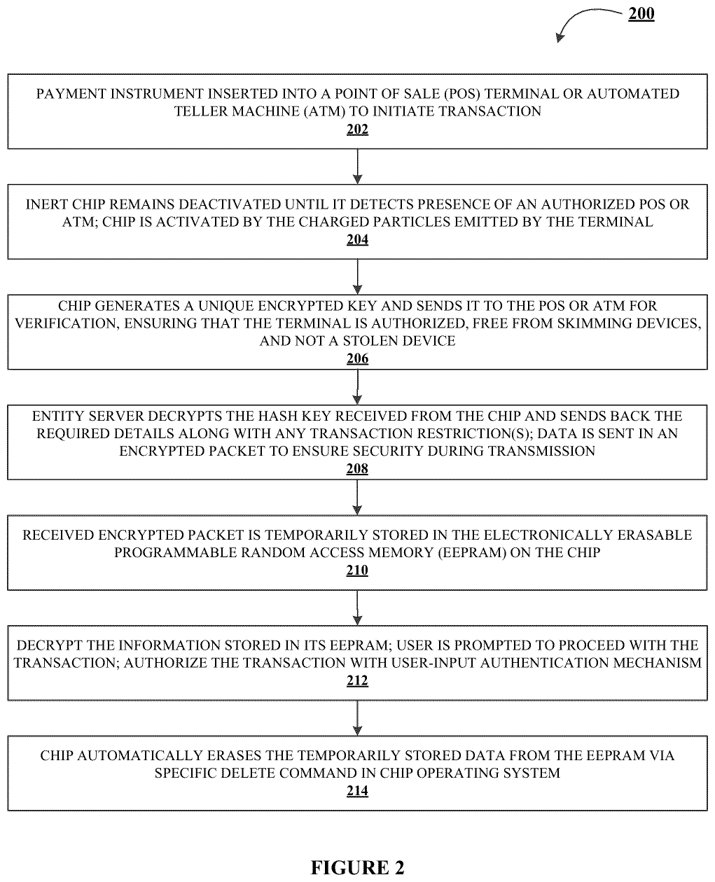

FIG. 2 illustrates a process flow for utilizing electrically erasable programmable random access memory for encrypted data retrieval, in accordance with an embodiment of the disclosure. The process begins whereby a payment instrument is inserted into a point of sale (POS) terminal or automated teller machine (ATM) to initiate a transaction, as indicated in block 202. In a preferred embodiment of this solution, the card activation process begins when a user inserts their payment instrument to the ATM or POS. In some embodiments, the chip embedded in the card is designed to be dormant until it receives a specific activation signal. This signal is generated by the POS or ATM when a card is inserted or swiped. The signal is typically a small electric impulse or a digital signal that is recognized by the chip as an activation command. This design ensures that the chip is only active during transactions, thereby conserving power and enhancing security.

It is understood that the chip itself is a sophisticated piece of hardware core to the inventive aspects of the present system. It contains an integrated circuit with multiple components: a microprocessor, memory units (including EEPRAM), and secure communication interfaces, or the like. The microprocessor is responsible for executing the instructions embedded in the chip firmware. This firmware includes the protocols for communicating with the POS or ATM and the entity server, as well as the algorithms for data encryption and decryption. The EEPRAM is used for the temporary storage of data during the transaction. In some embodiments, it is designed to be rewritable and capable of securely erasing the stored data after the transaction is completed. The communication interfaces facilitate the secure exchange of data between the chip and the POS or ATM, and subsequently between the chip and the entity server. These interfaces are designed to comply with industry standards for secure data transmission, such as SSL or TLS protocols (e.g., SSL (Secure Sockets Layer) and TLS (Transport Layer Security) are cryptographic protocols designed to provide secure communication over a computer network. They are widely used in applications like web browsing, email, instant messaging, and voice over IP (VOIP), with the primary purpose of ensuring privacy and data integrity between two communicating computer applications).

In alternative embodiments, the activation process might involve additional security features. For instance, the chip could be designed to require a biometric confirmation (such as a fingerprint scan, or the like) from the user, in addition to the activation signal from the POS or ATM, before it becomes active. This could be implemented using a biometric sensor embedded in the card. In other embodiments, another variation could involve the use of near-field communication (NFC) technology, where the chip is activated by a wireless signal from the POS or ATM when the card is brought into close proximity. These embodiments, while varying in their activation mechanisms, all share the core principle of activating the card's chip securely and only when necessary for a transaction, thereby enhancing the overall security and efficiency of the card usage.

The inert chip remains deactivated until it detects presence of an authorized POS or ATM. The chip is activated by the impulse of particles emitted by the terminal, as indicated by block 204. In the preferred embodiment, the POS or ATM authentication is a critical security measure to ensure that the cardholder is transacting through a legitimate and secure terminal. When the card is activated at a POS terminal or ATM, the embedded chip initiates a security check. This involves the chip sending a digital request to the entity server, asking to verify the authenticity and security status of the POS or ATM. The request includes the identification details (ID) of the POS or ATM, which, in some embodiments, is a unique code assigned to each terminal, or the like. This ID can be transmitted through established secure communication protocols, such as SSL or TLS, to ensure the request's integrity and confidentiality.

The entity server, upon receiving this request, performs a validation check against its database of registered and secure POS or ATM terminals. This database contains the details of each terminal, including its ID, location, security status, and transaction history. The server uses this information to determine whether the POS or ATM is legitimate and has not been reported for any misappropriation activities or skimming incidents. The server then sends a response back to the chip, confirming the status of the POS or ATM. If the POS or ATM is found to be compromised or unrecognized, the server can instruct the chip to abort the transaction, thereby preventing potential misuse.

In alternative embodiments, additional layers of security can be integrated. For example, the POS or ATM could be required to send a dynamically generated, time-sensitive code back to the bank server along with its ID. This code, which could be based on cryptographic algorithms, would provide an additional validation step, ensuring that the POS or ATM is not only legitimate but also currently secure. Another embodiment might involve real-time monitoring systems, where the entity server continuously evaluates the security status of POS or ATM terminals based on various parameters like transaction patterns, frequency, and external security reports. These embodiments emphasize the importance of robust, real-time authentication of POS or ATM terminals to safeguard against the evolving threats in card-based transactions. By implementing such sophisticated authentication processes, the chance of unauthorized transactions can be significantly reduced, enhancing the overall security of card usage in various transaction environments.

The chip generates a unique encrypted key and sends it to the POS or ATM for verification, ensuring that the terminal is authorized, free from skimming devices, and not a misappropriated device, as indicated in block 206. In a preferred embodiment of this solution, the chip embedded in the card is equipped with advanced cryptographic capabilities. When a transaction is initiated, the chip generates a unique encrypted key, a process integral to verifying the authenticity and security of the POS or ATM. This key is created using a sophisticated encryption algorithm, such as AES (Advanced Encryption Standard) or RSA (Rivest-Shamir-Adleman), ensuring that it is secure and virtually impossible to replicate or predict. The key generation is also dynamic, meaning a new key is produced for each transaction, thereby enhancing security.

Once generated, this key is transmitted to the POS or ATM using secure communication protocols. The POS or ATM, in turn, is equipped with corresponding cryptographic software that allows it to decrypt and analyze the key. This software, ideally, would be regularly updated to counteract evolving security threats. The terminal uses the decrypted key to authenticate itself to the card chip by sending a response back, which might include a signature or token that the chip can verify. This process ensures that the terminal is not only authorized but also free from skimming devices and not a misappropriated device. It acts as a two-way handshake, where both the card and the terminal validate each other.

In alternative embodiments, additional security layers can be implemented. For example, the POS or ATM could use a form of mutual authentication, where both the terminal and the card's chip must authenticate each other using a set of encrypted keys. This mutual authentication process might involve a more complex exchange of keys and encrypted tokens, enhancing the security of the transaction. Another variation could incorporate real-time threat analysis, where the POS or ATM sends transactional and environmental data back to the bank server, along with the chip's key. This data could include transaction frequency, terminal location changes, or unusual patterns that might indicate a security problem. The bank server could then analyze this data in real-time to provide an additional layer of security verification.

These embodiments demonstrate a comprehensive approach to ensuring the security and integrity of card transactions. By leveraging advanced encryption techniques and secure communication protocols, the card and the terminal can mutually authenticate each other, significantly reducing the chance of unauthorized transactions and enhancing customer trust in the security of their payment instruments.

The entity server decrypts the hash key received from the chip and sends back the required details along with any transaction restriction(s). The data is sent in an encrypted packet to ensure security during transmission, as indicated in block 208. In a preferred embodiment, the entity server, in some embodiments a server maintained by the entity institution or resource instrument issuer, plays a crucial role in the secure transaction process. When the chip on the card initiates a transaction, it generates and sends a cryptographic hash key to the entity server. This key is a unique identifier, created using a hash function like SHA-256 (Secure Hash Algorithm 256-bit) or another robust cryptographic hash algorithm, ensuring it is secure and unique to each transaction.

Upon receiving the hash key, the entity server uses its cryptographic software to decrypt it. This software is an integral part of the server's security infrastructure and is maintained and updated to adhere to the latest security standards and protocols. The decryption process verifies the authenticity of the transaction request and the integrity of the hash key. Once the key is decrypted and authenticated, the server retrieves the required card details and any associated transaction restrictions from its secure database. These details are then encrypted into a packet using a secure encryption protocol, such as TLS (Transport Layer Security), to safeguard the data during its transmission back to the card's chip. The encryption ensures that the data remains confidential and tamper-proof during transit.

In alternative embodiments, the security process can be enhanced in various ways. For instance, the entity server might employ a multi-factor authentication process before decrypting the hash key. This could include verifying the transaction against the cardholder's behavior patterns or geolocation data. Another variation could involve the use of decentralized ledger technology for additional security and transparency. In this scenario, each transaction could be recorded as a block in a private chain, providing a tamper-proof and verifiable record of transactions. Furthermore, the entity server could implement machine learning algorithms to detect and respond to unusual transaction patterns or potential security threats in real-time. These algorithms could analyze transaction data, detect anomalies, and trigger additional security checks or alerts as needed. These embodiments illustrate a multi-layered approach to transaction security, combining advanced cryptography, secure communication protocols, and intelligent security measures. By doing so, the entity server plays a pivotal role in ensuring the confidentiality, integrity, and authenticity of card transactions, thereby protecting both the cardholder and the financial institution from potential misuse.

The received encrypted packet is temporarily stored in the Electronically Erasable Programmable Random Access Memory (EEPRAM) on the chip, as indicated in block 210. In a preferred embodiment of this solution, once the encrypted packet containing the necessary transaction details and restrictions is received from the entity server, it is stored temporarily in the EEPRAM located on the chip embedded in the card. EEPRAM is a type of non-volatile memory, meaning it does not require power to maintain the stored information. However, unlike traditional non-volatile memories, EEPRAM can be electrically erased and reprogrammed, making it ideal for applications where data needs to be securely and temporarily stored.

In some embodiments, the chip's architecture in this embodiment includes a sophisticated memory management system. This system is responsible for securely writing the encrypted packet to the EEPRAM, ensuring that the data is stored correctly and remains intact during the transaction process. The system also manages the erasure of the data post-transaction to ensure that no residual data is left that could be utilized. Additionally, the memory management system includes safeguards against physical and logical attacks, ensuring the security of the data while it resides in the EEPRAM. Furthermore, the chip includes a dedicated cryptographic processor or module. This module is responsible for decrypting the received packet for the transaction and re-encrypting any data that needs to be sent back to the server or used in the transaction process. The cryptographic processor is designed to work with high-security standards, such as AES (Advanced Encryption Standard), and is optimized for fast and secure processing to ensure the transaction is not only safe but also efficient.

In alternative embodiments, additional security features can be integrated into the EEPRAM and the chip's architecture. For instance, the chip could be designed to include tamper-detection technology, which would trigger a secure erase of the EEPRAM contents if a physical breach is detected. Another variation could involve integrating real-time monitoring software on the chip, which would constantly check the integrity of the stored data and the operational status of the EEPRAM, alerting the user or the bank server in case of any anomalies. These embodiments demonstrate a robust and secure approach to handling sensitive transaction data. By utilizing EEPRAM for temporary data storage, along with advanced encryption and memory management technologies, the chip ensures that the cardholder's data is protected throughout the transaction process, thereby significantly reducing the chance of data misuse.

The system decrypts the information stored in its EEPRAM, and the user is then prompted to proceed with the transaction. The system may authorize the transaction with user-input authentication mechanism, as indicated in block 212. In a preferred embodiment, once the encrypted packet containing transaction data is stored in the EEPRAM of the chip, the system begins the decryption process. This is a crucial step where the embedded cryptographic processor in the chip plays a vital role. The processor uses advanced decryption algorithms, such as AES (Advanced Encryption Standard), to securely decrypt the packet. The decrypted data includes details necessary for the transaction, such as the account number, transaction amount, and any specific restrictions or rules set by the entity.

Once the data is decrypted, the card's system, through its interface with the POS or ATM, prompts the user to proceed with the transaction. This user interface could be a screen on the POS system or ATM displaying messages, or in some embodiments, it could also include audio prompts for accessibility. The user is asked to confirm the transaction details and proceed to the authentication phase. The authentication mechanism may vary depending on the system's design and user preference. Common methods include PIN entry, signature verification, or, in more advanced systems, biometric verification such as fingerprint or facial recognition.

The system's architecture in this embodiment is designed to support various user-input authentication mechanisms. This includes a secure input interface where the user can enter their PIN or other authentication details. The system ensures that this input is securely processed and transmitted, protecting it from interception or tampering. In cases where biometric authentication is used, the system includes a biometric sensor integrated into the card or the POS/ATM, capable of capturing and processing biometric data. In alternative embodiments, additional security and user convenience features can be integrated. For instance, some systems might use a contactless transaction process, where the card communicates with the POS/ATM using Near Field Communication (NFC) technology. In such cases, the authentication might include a two-factor process, combining something the user has (the card) with something the user knows (a PIN) or is (a biometric trait). Another variation could involve the use of a mobile device in the authentication process, where the user can authenticate the transaction through a mobile application, adding an extra layer of security. It is understood that by integrating advanced decryption technology, secure user interfaces, and versatile authentication mechanisms, the system ensures the transaction is not only secure but also user-friendly, accommodating a wide range of user preferences and enhancing the overall transaction experience.

Chip automatically erases the temporarily stored data from the EEPRAM via specific delete command in chip operating system, as indicated in block 214. In a preferred embodiment, the secure erasure of data from the EEPRAM after a transaction is a critical aspect of maintaining the security integrity of the payment system. Once a transaction is completed, the chip operating system (OS), which manages the overall functioning of the chip, executes a specific delete command. This command is designed to securely and completely erase the temporarily stored data in the EEPRAM, ensuring that no residual information is left that could be potentially utilized.

The delete command in the chip OS is a part of a broader set of security protocols embedded within the firmware of the chip. These protocols are specifically designed to ensure data integrity and security. The deletion process is not just a simple removal of data but involves overwriting the memory sectors where the data was stored. This overwriting can be done using specific patterns or values to ensure that the original data cannot be recovered or reconstructed. The chip's firmware also includes mechanisms to verify that the data has been successfully erased, adding an additional layer of security.

In addition to the secure deletion protocols, the chip OS includes various other security features. For instance, in some embodiments it may have built-in measures to detect and prevent tampering or unauthorized access attempts. These could include monitoring for unusual patterns of memory access or attempts to bypass the chip security protocols. In alternative embodiments, the approach to data erasure and overall security can vary. For instance, some designs might implement a more complex multi-stage deletion process, where the data is first de-encrypted, then scrambled, and finally overwritten with random data. Another variation could include real-time monitoring of the EEPRAM's integrity, with the system being able to initiate an emergency data wipe if a security breach is detected.

Furthermore, for enhanced security, some embodiments might implement a physical security feature, such as a self-destruct mechanism, where the EEPRAM physically destroys itself in the event of tampering. This could be especially relevant in high-security applications. These embodiments highlight the importance of secure data management in payment systems. By incorporating sophisticated data erasure protocols along with comprehensive security measures in the chip OS, the payment system ensures that sensitive data is protected throughout the transaction process and beyond, maintaining the trust and security essential in financial transactions.

It is understood that, depending on the embodiment of the invention, the choice of OS would depend on various factors including the complexity of the tasks the chip needs to perform, the level of security required, resource constraints of the chip, and the need for connectivity. For a payment system, the OS must support strong cryptographic functions, secure data storage, and efficient real-time processing, all while being highly resistant to tampering and hacking attempts. One exemplary OS would be an OS specifically designed for smartcards and allows applications written in Java to be run securely on smartcards and similar small-memory devices.

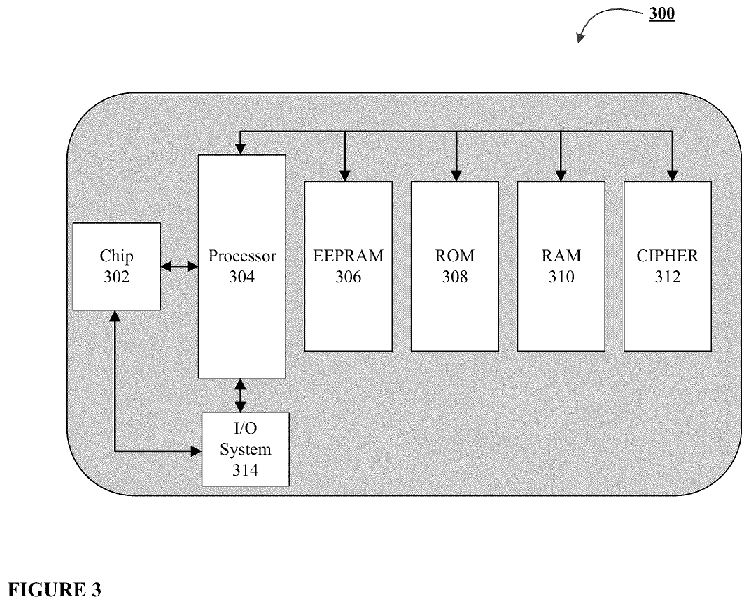

FIG. 3 illustrates an instrument 300 utilizing electrically erasable programmable random access memory for encrypted data retrieval, in accordance with an embodiment of the disclosure. FIG. 3 includes a diagram of a resource instrument with various integrated components, each playing a specific role in the functionality of the instrument. The components are labeled with numbers for identification, including chip 302, processor 304, EEPRAM 306, ROM 308, RAM 310, CIPHER 312, and I/O system 314.

Chip 302 is the central unit of the instrument utilizing electrically erasable programmable random-access memory for encrypted data retrieval, and in some embodiments contains an integrated circuit that communicates with external devices through contact or contactless methods. Chip 302 serves as a coordinating component between the various components to perform transactions, authentication, and other functions. The processor 304 is the computational component of the card, executing the instructions contained in the instrument utilizing electrically erasable programmable random-access memory for encrypted data retrieval's OS and applications. It processes all the cryptographic operations and manages communications with external terminals like ATMs and POS systems. In some embodiments, it is a secure microcontroller specialized for handling sensitive operations securely. EEPRAM 306 represents Electronically Erasable Programmable Read-Only Memory, which is a non-volatile memory used in the instrument utilizing electrically erasable programmable random-access memory for encrypted data retrieval to temporarily store sensitive data during transactions, as previously discussed. It can be electrically erased and reprogrammed, which allows for the secure deletion of data after each transaction.

In some embodiments, the EEPRAM is configured to overwrite the stored encrypted data packet with random data upon erasure to prevent data recovery via physical memory analysis. This process, often referred to as data sanitization or secure deletion, is employed to mitigate the chance of sensitive information being recovered through physical memory analysis, a technique used in data forensics. Upon completion of a transaction, when the transaction details are no longer needed, the EEPRAM engages a secure wipe protocol. Instead of merely deleting pointers to the data, the memory cells that held the encrypted data packet are filled with patterns of meaningless data, thereby obfuscating the original information. This method of overwriting is critical in environments where data privacy is paramount, effectively ensuring that once transaction details are erased, they cannot be reconstructed or retrieved by unauthorized entities.

ROM 308 represents Read-Only Memory and stores the card's operating system and other critical, unchangeable data. This might include the instrument utilizing electrically erasable programmable random-access memory for encrypted data retrieval's firmware, security protocols, and cryptographic keys that are required for the instrument utilizing electrically erasable programmable random access memory for encrypted data retrieval to operate but are not meant to be altered after manufacture. RAM 310 signifies Random Access Memory and is the instrument utilizing electrically erasable programmable random access memory for encrypted data retrieval's temporary working memory, used by the processor to store and manipulate data while performing tasks. The RAM 308 is volatile memory, meaning that it requires power to maintain its state and is cleared when the instrument utilizing electrically erasable programmable random access memory for encrypted data retrieval is not powered.

CIPHER 312 represents the cryptographic unit or module of the instrument utilizing electrically erasable programmable random access memory for encrypted data retrieval, dedicated to performing all encryption and decryption processes. The hardware of CIPHER 312 is optimized for cryptographic functions like generating hash keys, encrypting and decrypting data packets, and ensuring secure communication. Finally, the I/O system 314 represents an Input/Output System, and handles all communications between the instrument utilizing electrically erasable programmable random access memory for encrypted data retrieval chip and external devices. The I/O system 314 ensures the proper flow of data into and out of the card, facilitating data exchange with POS terminals, ATMs, and entity servers during transactions. It is understood that each number corresponds to a particular component, providing a clear map of the instrument utilizing electrically erasable programmable random access memory for encrypted data retrieval internal structure and function.

It is understood that the instrument may include various other components not pictures in FIG. 3. For instance, the instrument may include an NPU (Neural Processing Unit). An NPU is a specialized processor designed for the acceleration of machine learning algorithms. It can handle complex computations typically associated with neural networks, providing capabilities for advanced data processing tasks such as pattern recognition or predictive analysis. In some embodiments, the instrument circuitry may include a clock mechanism, which provides a signal to synchronize the operations of the microcontroller's components. One of ordinary skill will appreciate that the clock ensures that all parts of the system work together in a timed sequence. Furthermore, the instrument may include a reset component. The reset line is used to initialize the system, putting all components into a known state. This is typically used during power-up or when the system needs to be recovered from an error state. In some embodiments, the instrument architecture may include a voltage common collector. The voltage common collector is the power supply line for the system. It provides the necessary voltage for the system to operate. In some embodiments, the instrument architecture may also include a ground. The ground line completes the circuit's electrical path and is a common reference point for all voltages in the system.

The architecture overall is indicative of a sophisticated, multifunctional secure processing unit capable of handling complex tasks, including secure transactions and potentially advanced data processing or machine learning tasks, as indicated by the presence of an NPU. One of ordinary skill will appreciate that the inclusion of differing varieties of memory units (RAM, EEPRAM, and ROM) indicates a system designed to handle a variety of operations requiring both temporary and permanent data storage.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for utilizing electrically erasable memory for encrypted data retrieval, the system comprising:
a processing device;
a non-transitory storage device containing instructions when executed by the processing device, causes the processing device to perform the steps of:
initiating a communication link with a server upon receiving an activation signal from a point-of-sale (POS) terminal or an automated teller machine (ATM);
generating a unique cryptographic hash key and transmitting the unique cryptographic hash key to the server for authentication of the POS terminal or the ATM;
receiving an encrypted data packet from the server, wherein the encrypted data packet comprises transaction details;
temporarily storing the encrypted data packet in an electronically erasable programmable read-only memory (EEPRAM) of a resource instrument;
decrypting the encrypted data packet stored in the EEPRAM to retrieve the transaction details; and
erasing the transaction details from the EEPRAM subsequent to the completion of a transaction.

2. The system of claim 1, wherein the system is further configured to cause the processing device to perform the steps of:
transmitting a user interface to the POS terminal or ATM to prompt a user to authenticate the transaction based on the transaction details; and
conducting the transaction upon successful authentication by the user.

3. The system of claim 2, wherein the user interface includes one or more input fields for receiving a personal identification number (PIN) or a biometric input from the user as a means of authentication.

4. The system of claim 3, wherein the transaction restrictions include at least one of a transaction limit, geographic usage limit, or merchant category restriction.

5. The system of claim 1, wherein the transaction details further comprise transaction restrictions of the resource instrument.

6. The system of claim 1, wherein the system is further configured to cause the processing device to perform the step of: generating an alert if the unique cryptographic hash key fails to authenticate the POS terminal or the ATM, preventing the transaction from proceeding.

7. The system of claim 1, wherein the EEPRAM is configured to overwrite any stored encrypted data packet with random data upon erasure to prevent data recovery via physical memory analysis.

8. A computer program product for utilizing electrically erasable programmable random access memory for encrypted data retrieval, the computer program product comprising a non-transitory computer-readable medium comprising code causing an apparatus to perform the steps of:
initiating a communication link with a server upon receiving an activation signal from a point-of-sale (POS) terminal or an automated teller machine (ATM);
generating a unique cryptographic hash key and transmitting the unique cryptographic hash key to the server for authentication of the POS terminal or the ATM;
receiving an encrypted data packet from the server, wherein the encrypted data packet comprises transaction details;
temporarily storing the encrypted data packet in an electronically erasable programmable read-only memory (EEPRAM) of a resource instrument;
decrypting the encrypted data packet stored in the EEPRAM to retrieve the transaction details; and
erasing the transaction details from the EEPRAM subsequent to the completion of a transaction.

9. The computer program product of claim 8, wherein the code further causes the apparatus to perform the steps of:
transmitting a user interface to the POS terminal or ATM to prompt a user to authenticate the transaction based on the transaction details; and
conducting the transaction upon successful authentication by the user.

10. The computer program product of claim 9, wherein the user interface includes one or more input fields for receiving a personal identification number (PIN) or a biometric input from the user as a means of authentication.

11. The computer program product of claim 10, wherein the transaction restrictions include at least one of a transaction limit, geographic usage limit, or merchant category restriction.

12. The computer program product of claim 8, wherein the transaction details further comprise transaction restrictions of the resource instrument.

13. The computer program product of claim 8, wherein the code further causes the apparatus to perform the step of: generating an alert if the unique cryptographic hash key fails to authenticate the POS terminal or the ATM, preventing the transaction from proceeding.

14. The computer program product of claim 8, wherein the EEPRAM is configured to overwrite any stored encrypted data packet with random data upon erasure to prevent data recovery via physical memory analysis.

15. A method for utilizing electrically erasable programmable random access memory for encrypted data retrieval, the method comprising:
initiating a communication link with a server upon receiving an activation signal from a point-of-sale (POS) terminal or an automated teller machine (ATM);
generating a unique cryptographic hash key and transmitting the unique cryptographic hash key to the server for authentication of the POS terminal or the ATM;
receiving an encrypted data packet from the server, wherein the encrypted data packet comprises transaction details;
temporarily storing the encrypted data packet in an electronically erasable programmable read-only memory (EEPRAM) of a resource instrument;
decrypting the encrypted data packet stored in the EEPRAM to retrieve the transaction details; and
erasing the transaction details from the EEPRAM subsequent to the completion of a transaction.

16. The method of claim 15, wherein the method further comprises:
transmitting a user interface to the POS terminal or ATM to prompt a user to authenticate the transaction based on the transaction details; and
conducting the transaction upon successful authentication by the user.

17. The method of claim 16, wherein the user interface includes one or more input fields for receiving a personal identification number (PIN) or a biometric input from the user as a means of authentication.

18. The method of claim 17, wherein the transaction restrictions include at least one of a transaction limit, geographic usage limit, or merchant category restriction.

19. The method of claim 15, wherein the transaction details further comprise transaction restrictions of the resource instrument.

20. The method of claim 15, wherein the method further comprises: generating an alert if the unique cryptographic hash key fails to authenticate the POS terminal or the ATM, preventing the transaction from proceeding.
